(19) United States
(12) Patent Application Publication
(10) Pub. No.: US 2010/0302187 A1
(43) Pub. Date: Dec. 2, 2010

(54) APPARATUS HAVING A WORKING SURFACE ACTING AS BOTH A HANDWRITING SURFACE AND AN INPUT SURFACE OR COMMAND MODULE

(76) Inventors: Jacques Cinqualbre, Rosheim (FR); Jean-Yves Lux, Boersch (FR)

Correspondence Address: OSHA LIANG L.L.P., TWO HOUSTON CENTER, 909 FANNIN, SUITE 3500, HOUSTON, TX, 77010, US

(21) Appl. No.: 12/786,164

(22) Filed: May 24, 2010

Related U.S. Application Data
(60) Provisional application No. 61/180,736, filed on May 22, 2009.

(51) Int. Cl. G06F 3/041; G09G 5/00

(52) U.S. Cl. 345/173; 345/156

(57) ABSTRACT

In one aspect, embodiments of the present disclosure relate to a computer interface providing a writing surface. The computer interface includes a planer surface comprising an input unit, a display surface comprising a display unit, and a mode button configured to switch the planer surface between an active mode in which data may entered by the input unit and a deactivated mode in which the planer surface is a writing surface.

### CROSS-REFERENCE TO RELATED APPLICATIONS

This application claims the benefit of U.S. Provisional Application 61/180,736 filed on May 22, 2009, the entire contents of which are hereby incorporated by reference.

### BACKGROUND OF INVENTION

1. Field of the Disclosure

The present disclosure relates to an apparatus allowing a user to use a working surface for multiple purposes.

2. Description of the Related Art

Mobile carts may be employed in, for example, healthcare institutions to provide, among other things, data access, electronic record keeping, and/or surfaces upon which handwritten notes may be taken. In current mobile carts a computer may be provided with a keyboard in a planer surface.

### SUMMARY OF INVENTION

In one aspect, embodiments of the present disclosure relate to a computer interface providing a writing surface. The computer interface includes a planer surface comprising an input unit, a display surface comprising a display unit, and a mode button configured to switch the planer surface between an active mode in which data may entered by the input unit and a deactivated mode in which the planer surface is a writing surface.

In another aspect, embodiments of the present disclosure relate to a computer including a display unit, an input unit, and a mode button configured to switch the planer surface between an active mode in which data may entered by the input unit and a deactivated mode in which the planer surface is a writing surface.

In another aspect, embodiments of the present disclosure relate to a method of converting a writing surface to an input unit. The method includes providing an input unit in a planer surface and operating a mode button configured to switch the planer surface between an active mode in which data may entered by the input unit and a deactivated mode in which the planer surface is a writing surface.

In another aspect, embodiments of the present disclosure relate to a medical cart including a display unit, a planer surface, and a mode button configured to switch the planer surface between an active mode in which data may entered by the input unit and a deactivated mode in which the planer surface is a writing surface.

### BRIEF DESCRIPTION OF DRAWINGS

FIG. 1 is a schematic view of an apparatus in accordance with one or more embodiments of the present disclosure;

FIG. 2 is a schematic view of an apparatus in accordance with one or more embodiments of the present disclosure;

FIG. 3 is a schematic view of internal components of the apparatus shown in FIGS. 1 and 2.

FIG. 4 is a schematic view of an apparatus in accordance with one or more embodiments of the present disclosure.

FIG. 5 is a schematic view of an apparatus in accordance with one or more embodiments of the present disclosure.

### DETAILED DESCRIPTION

An apparatus allowing for a surface to serve multiple purposes in accordance with one or more embodiments will be described herein with reference to the accompanying drawings.

In current usage, an input unit may be electronically controlled by software of a computer such that the input unit may be activated or deactivated. In an activated state, the input unit may provide control and/or input for the computer. In a deactivated state, the input unit may be non-functional, and the surface input unit may allow for a user to write and/or draw on the surface where the input unit is located without interfering with the computer or the writing.

In the deactivated state, the surface where the input unit is located may be used as a writing surface. However, the input unit must be deactivated, because, if the input unit is active during handwriting, inputs may be made to the computer that may be unintentional or destructive to data. Accordingly, in order to deactivate the input unit to allow for handwriting, a user may control the computer such that the software of the computer may deactivate the input unit, so that unintentional entries and/or inputs may be avoided.

It may be advantageous to have a control button that may activate or deactivate the input unit without interacting with the computer system. Accordingly, embodiments disclosed herein relate to an apparatus with multiple functions. Specifically, a surface may be provided that may allow for both electronic inputs, such as with a keyboard and/or touch pad, and a writing surface. The writing surface may be a surface upon which drawings and/or writing may be made without activating the electronic inputs. Further, the writing surface may be used to hold items of interest or to display such items, without activating the electronic inputs. Accordingly, in accordance with one or more embodiments of the present disclosure, a mode button may be provided that may control a touch sensitive surface that may easily activate and/or deactivate the touch sensitive surface, allowing for easy switching between an electronic input surface and a writing surface.

The electronic input may be provided on a planer surface, and a display unit may be provided on a display surface attached thereto, each part of a case that may include a computer. The planer surface may be substantially and/or completely smooth, thereby allowing for easy handwriting and/or drawing without interference from irregularities or asperities within the planer surface. A mode button may be provided and may be a touch sensitive button that may allow for activation and/or deactivation of the touch sensitive surface. Further, the mode button may not be tied to and/or associated with an operating system and/or application that may be displayed on the display unit in the display surface. Accordingly, the display unit may continue to function even after the touch sensitive surface is deactivated. Additionally, the display unit may not be required to activate and/or deactivate the touch sensitive surface.

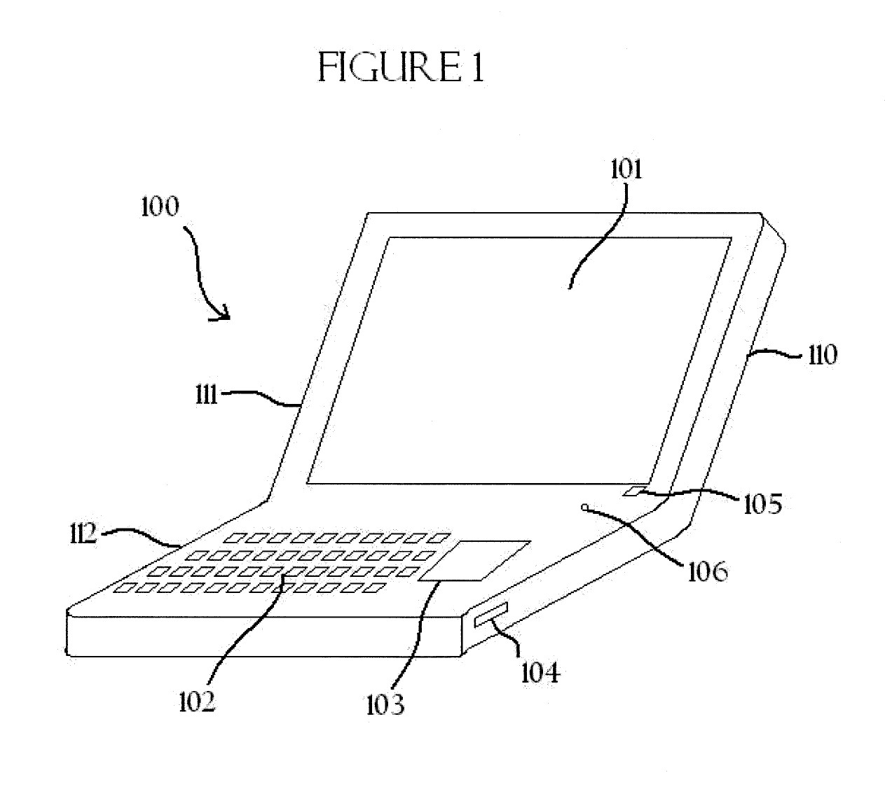

Referring to FIG. 1, a schematic view of an apparatus in accordance with one or more embodiments of the present disclosure is shown. Apparatus 100 includes a case 110 with an display surface 111 and a planer surface 112. Display surface 111 may include a display unit 101 disposed therein. Planer surface 112 may be a touch sensitive surface and may include an input unit 102 and/or an input pad 103 (hereinafter referred to as input unit 102). Those skilled in the art will appreciate that input unit 102 may include alphanumeric keys, function keys, pictorial representations, and/or any other functional input buttons and/or symbols that may be used as input into a computer or other electronic device. Further, input pad 103 may include standard functions of a mouse or other electronic input device, such as a laptop touch pad. The functions of input unit 102 may be associated with specific functions and/or associated with data, such as complex medical records.

Display unit 101 may be a touch screen display unit that may allow for direct input to a computer (not shown) through the screen. The computer may be housed within case 110 or may be remote from display 101 and case 110, such as in a separate computer case. Alternatively, display unit 101 may be a non-interactive display surface or may be interactive with an input device, such as a remote control, an electronic pen and/or stylus, and/or other device. Display unit 101 may be controlled by a computer or other similar device that may display a user interface that may allow for a user to observe and/or interact with data and/or applications displayed thereon.

Input unit 102 may be a capacitive touch, resistive touch, ultrasonic activated, and/or other touch based surface. For example, input unit 102, including an input pad, may be a capacitive touch surface. Accordingly, planer surface 112 may be substantially smooth, allowing for a surface without any asperity and/or irregularity. Input unit 102 may be a printed or engraved keyboard, such that the planer surface may be engraved on an interior side of case 110, so that the surface to be used as the keyboard may be smooth (planer surface 112).

Case 110 may also have a digital media reader, such as a USB port, SD card port, CD drive, and/or other digital media format port and/or reader.

Case 110 may also have an indicator 106 disposed thereon to indicate whether the input unit 102 is active or inactive. For example, the indicator 106 may be a light, such as a light emitting diode (LED), which may be on when input unit 102 is active, and off when input unit 102 is inactive. Alternatively, indicator 106 may display a first color when input unit 102 is active and a second color when input unit 102 is inactive.

Mode button 105 may control both the active and inactive status of input unit 102 and also the on/off or color of indicator 106, such that the two elements (input unit 102 and indicator 106) are operated by the single mode button 105. As noted above, mode button 105 may be independent from the operating system and/or applications displayed on display unit 101. Accordingly, mode button 105 may be configured to switch the planer surface between an active mode in which data may entered by the input unit and a deactivated mode in which the planer surface is a writing surface.

Mode button 105 may be a capacitive touch, resistive touch, ultrasonic application, or other type of activated sensor. Accordingly, input unit 102 may easily be activated or inactivated by a simple touch on the case 110. Therefore, activation and deactivation of input unit 102 may not be controlled by an application or software, thereby eliminating the need for a user to interact with the system in order to activate or deactivate input unit 102. Further, although shown just below display unit 101, those skilled in the art will appreciate that mode button 105 may be located anywhere on case 110 or may be located on another element, such as on a cart to which apparatus 100 may be attached. Accordingly, mode button 105 may be located remote from input unit 102.

As shown in FIG. 1, input unit 102 is in an active state. In this state, input unit 102 may allow for a user to input electronic data into a computer or software, as displayed on display unit 101. Input pad 103 may allow a user to operate a mouse or other movable indicator on display unit 101 and input unit 102 may allow for character entry and/or application control.

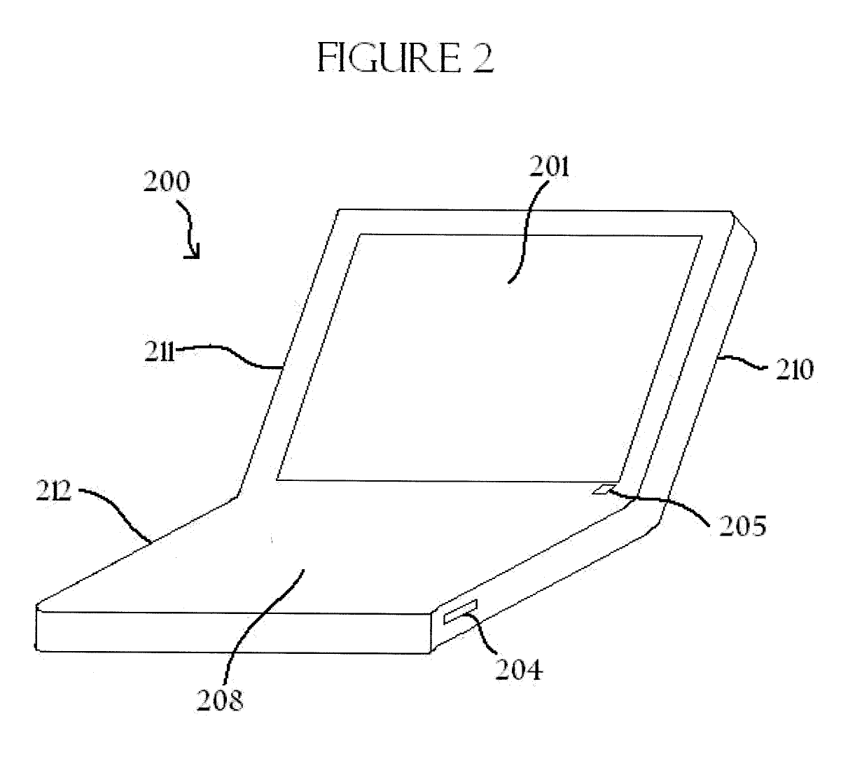

As shown in FIG. 2, the input unit of apparatus 200 is in a deactivated state. Planer surface 212 is merely a smooth surface upon which a user may write, draw, and/or place objects, such as charts. Because the input unit is deactivated, writing, drawing, and/or placing objects on planer surface 212 will not affect programs that are normally operated and/or controlled by the input unit. Planer surface 212 merely becomes a smooth surface to be used by a user without interacting with the display 202 disposed in display surface 211 of case 210. Further, as noted above, display unit 201 may be a touch screen, thereby allowing interaction with the system directly through interaction with display unit 201. Similar to apparatus 100, apparatus 200 may have a digital media reader 204. Further, as shown, a mode button 205 may be located on case 210 remote from planer surface 212. Mode button 205 may therefore allow a user to easily reactivate the input unit when desired. Further, as noted above, mode button 205 may be located remote from the input unit, thereby preventing unintentional operation of mode button 205.

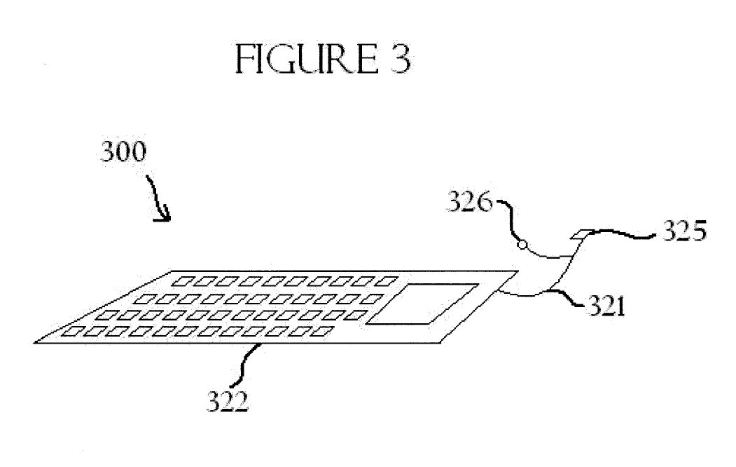

Now, referring to FIG. 3, internal components of the case in accordance with embodiments of the present disclosure are shown. Apparatus 300 includes a printed circuit board (PCB) 322 or any other mapped electronic or mechanical surfaces which may allow for input by capacitive touch, resistive touch, ultrasonic application, and/or other electronic or mechanical interaction. PCB 322 may correspond to the character mapping of the input unit described above.

PCB 322 may further be electronically coupled to a mode button 325 by a wire 321 or other electrical means. Mode button 325 may further be electronically coupled 321 to an indicator 326 in a similar fashion. By touching mode button 325 a user may activate both indicator 326 and PCB 322 or may deactivate indicator 326 and PCB 322. Both indicator 326 and PCB 322 may be simultaneously activated or deactivated by operation of mode button 325. Further, as described above, indicator 326 may indicate a state of activity of the input unit by a change in color instead of by turning on or off. For example, the indicator may show a green color when the input unit is active and a red color when the input unit is inactive.

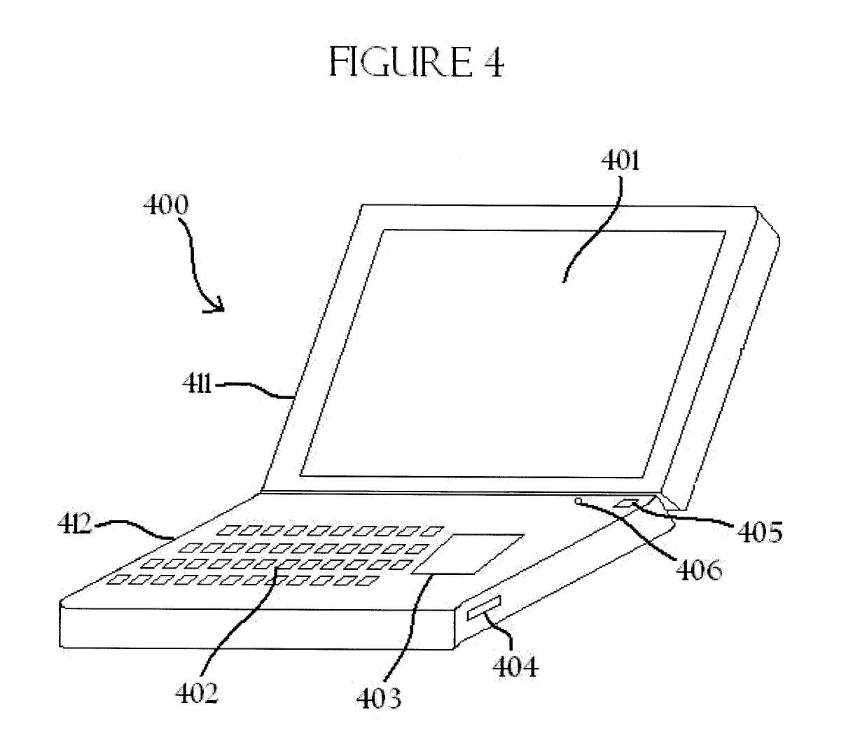

Now turning to FIG. 4, apparatus 400 in accordance with one or more embodiments of the present disclosure is shown. As shown, monitor 411 is separate from planer surface (or writing surface) 412. Accordingly, any monitor may be configured with the planer surface described herein. Monitor 411 may have a display screen 401, which may be a touch screen.

Further, planer surface 412 may have a touch sensitive keyboard 402 and/or touch pad 403, as described above. Planer surface 412 may also have a digital media reader 404. Similar to that described above, a touch sensitive mode button 405 may be provided on planer surface 412. An indicator 406 may also be located on the surface of planer surface 412, configured to indicate whether the input units, keyboard 402 and pad 403, may be active or inactive.

As shown, mode button 405 may be disposed on the planer surface 412. Alternatively, the mode button 405 may be disposed on other surfaces of the planer surface 412, on the monitor 411, or on other surfaces. Alternatively still, mode button 405 may be provided as a touch sensitive mode button on a wire remote or other similar structure attached to apparatus 400.

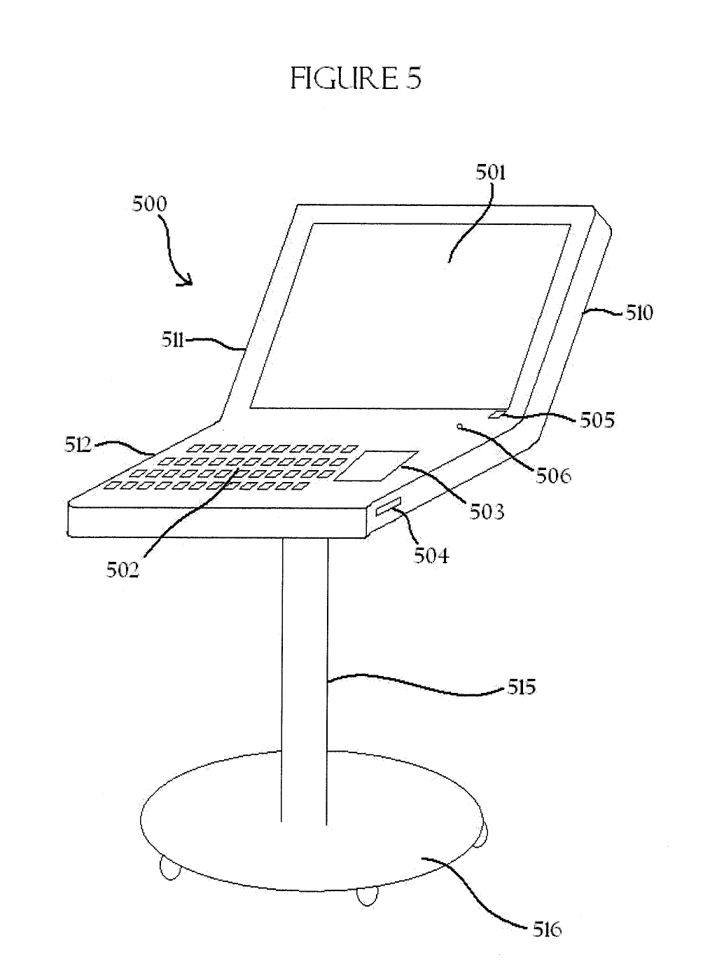

Now referring to FIG. 5, apparatus 500 in accordance with one or more embodiments of the present disclosure is shown. Apparatus 500 may include an display surface 511, with a display unit 501, and a planer surface (writing surface) 512, each part of a case 510. Planer surface 512 may include a touch sensitive keyboard 502 and/or a touch sensitive pad 503, as discussed above. Case 510 may also have a digital media reader 504, as discussed above.

Case 510 may also have a touch sensitive mode button 505 as described above. Mode button 505 may control activation and deactivation of the input unit(s), including keyboard 502 and pad 503.

Apparatus 500 may also include a stand 515 and base 516. Base 516 may include wheels or other parts that may allow for apparatus 500 to be mobile. Stand 515 and base 516 may form a mobile cart upon which the writing/input surface may be moved. Accordingly, a mobile cart may be provided that may allow for a mobile writing surface, a mobile input unit, and/or a mobile display unit.

Advantageously, embodiments disclosed herein may allow for instantaneous activation and/or deactivation of a touch sensitive input device on a useable surface. For example, a capacitive touch keyboard may be instantly deactivated by the simple touch of a capacitive mode button, thereby allowing use of the useable surface for non-input purposes.

Moreover, an indicator may be provided that allows a user to be notified of the status of the input surface. A light may be on, indicating that the touch surface is active, and the light may be off to indicate that the touch surface is inactive. Alternatively, in accordance with embodiments disclosed herein, the indicator may indicate a first color indicating that the touch surface is active and a second color indicating that the surface is inactive. Furthermore, a pulsing light or other type of indicator may be used without deviating from the scope of the present disclosure.

Moreover, the mode button, as disclosed herein, may be located remote from the input surface the mode button may control, thereby allowing easy control over the input surface. Further, as the mode button may be remote from the input surface the mode button control, inadvertent activation or deactivation may be avoided.

Moreover, the mode button, as disclosed herein, may allow simple operation (activation/deactivation) of a touch surface independent from an operating system, application, and/or other computer or electronically controlled display system. Accordingly, a user may activate or deactivate the touch surface without having to interact with a display or program displayed thereon.

Moreover, embodiments disclosed herein may allow for a planer surface to serve as both a writing surface and an input unit (such as a keyboard). The writing surface/input unit may be electrically connected to a display unit, which may be attached to the surface/input unit or may be separate therefrom.

Moreover, embodiments disclosed herein may allow for a mobile cart. For example, a mobile medical cart may be provide which may allow a user to employ a computer with a keyboard and also may allow for a smooth surface upon which writing, drawing, or displaying may be done.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

What is claimed is:

1. A computer interface providing a writing surface, the computer interface comprising:
a planer surface comprising an input unit;
a display surface comprising a display unit; and
a mode button configured to switch the planer surface between an active mode in which data may entered by the input unit and a deactivated mode in which the planer surface is a writing surface.

2. The computer interface of claim 1, wherein at least one of the input unit and the mode button comprise touch sensitive surfaces.

3. The computer interface of claim 2, wherein the touch sensitive surfaces are capacitive touch surfaces.

4. The computer interface of claim 1, wherein the mode button is disposed remote from the input unit.

5. The computer interface of claim 1, wherein the planer surface and the display surface comprise a single unitary structure.

6. The computer interface of claim 1, wherein the display unit comprises a touch screen.

7. The computer interface of claim 1, further comprising an indicator configured to indicate an activated or deactivated state of the input unit.

8. The computer interface of claim 7, wherein the mode button is configured to control the input unit and the indicator.

9. The computer interface of claim 1, wherein the input unit comprises a keyboard.

10. The computer interface of claim 1, wherein the planer surface is configured to provide a writing surface when the input unit is in a deactivated state.

11. The computer interface of claim 1, further comprising a controller configured to operate the mode button after a predetermined time.

12. The computer interface of claim 1, further comprising a cart configured to be mobile and support the planer surface and the display surface.

13. A computer comprising:
a display unit;
an input unit; and
a mode button configured to switch the planer surface between an active mode in which data may entered by the input unit and a deactivated mode in which the planer surface is a writing surface.

14. The computer of claim 13, wherein the display unit and the input unit comprise a single unitary structure.

15. The computer of claim 13, wherein the input unit comprises a writing surface when in a deactivated state.

16. The computer of claim 13, wherein the input unit comprises a keyboard.

17. The computer of claim 13, wherein at least one of the input unit and the mode button comprise touch sensitive surfaces.

18. The computer of claim 13, further comprising a cart configured to be mobile and support the display unit and the input unit.

19. A method of converting a writing surface to an input unit, the method comprising:
providing an input unit in a planer surface; and
operating a mode button configured to switch the planer surface between an active mode in which data may entered by the input unit and a deactivated mode in which the planer surface is a writing surface.

20. The method of claim 19, further comprising:
converting the input unit into the writing surface by pressing the mode button to deactivate the keyboard.

21. A medical cart comprising:
a display unit;
a planer surface; and
a mode button configured to switch the planer surface between an active mode in which data may entered by the input unit and a deactivated mode in which the planer surface is a writing surface.
